(19) United States
(12) Patent Application Publication
(10) Pub. No.: US 2012/0160116 A1
(43) Pub. Date: Jun. 28, 2012

(54) IDENTIFICATION MARK PRINTING MACHINE

(76) Inventor: Yutaka Endo, Ibaraki (JP)

(21) Appl. No.: 13/327,604

(22) Filed: Dec. 15, 2011

(30) Foreign Application Priority Data
Dec. 24, 2010 (JP) 287915/2010

(51) Int. Cl. B41F 7/02

(52) U.S. Cl. 101/217

(57) ABSTRACT

An identification mark printing machine including an impression cylinder, identification mark cylinder, transfer cylinder, inspection cylinder, and inspection device. The impression cylinder holds and transports a sheet having an image printed on it. The identification mark cylinder is in contact with the impression cylinder, and further prints an identification mark on the sheet held on the impression cylinder. The transfer cylinder is in contact with the impression cylinder on the downstream side, in the direction in which the sheet is transported, and holds and transports the sheet received from the impression cylinder. The inspection cylinder is in contact with the transfer cylinder, and holds and transports the sheet received from the transfer cylinder. The inspection device inspects the identification mark printed on the sheet held on the inspection cylinder.

### BACKGROUND OF THE INVENTION

The present invention relates to a identification mark printing machine which additionally prints a number and/or a seal on a sheet.

A identification mark printing machine of this type includes an impression cylinder which holds and transports a sheet fed from a sheet feed unit, a seal cylinder which is opposed to the impression cylinder and prints a seal on the sheet, a number printing cylinder which is opposed to the impression cylinder and prints a number on the sheet, delivery grippers which grip the sheet having the seal and number printed on it, and transport it as delivery chains travel, and a sheet delivery unit which delivers the sheet transported by the delivery grippers, as proposed in Japanese Patent Laid-Open No. 2000-85095.

The conventional identification mark printing machine as described above includes no inspection device which inspects the quality of the printed seal and number. For this reason, to inspect the quality of the seal and number, all sheets which are printed by the identification mark printing machine and delivered are carried into an inspection room, and inspected by visual inspection or an inspection device in the inspection room. Therefore, the inspection accuracy is not stable, and a special operator dedicated to inspection is necessary. Also, the operator's burden is heavy, and the productivity lowers. Furthermore, if a defective product occurs, sheets may be wasted in large amounts.

### SUMMARY OF THE INVENTION

It is an object of the present invention to provide a identification mark printing machine capable of stable inspection.

It is another object of the present invention to provide a identification mark printing machine which minimizes the number of waste sheets to improve the productivity.

In order to achieve the above-mentioned objects, according to the present invention, there is provided a identification mark printing machine comprising an impression cylinder which holds and transports a sheet having an image printed thereon, an identification mark cylinder which is in contact with the impression cylinder, and further prints an identification mark on the sheet held on the impression cylinder, a transfer cylinder which is in contact with the impression cylinder on a downstream side, in a direction in which the sheet is transported, of a position at which the impression cylinder and the identification mark cylinder are in contact with each other, and holds and transports the sheet received from the impression cylinder, an inspection cylinder which is in contact with the transfer cylinder, and holds and transports the sheet received from the transfer cylinder, and an inspection device which inspects the identification mark printed on the sheet held on the inspection cylinder.

According to the present invention, the number of waste sheets can be reduced by inspecting the quality of a seal or number immediately after the seal or number is printed. Also, since no special inspection operator is necessary, it is possible to considerably reduce the cost and improve the productivity as a result of a reduction in number of inspection processes. Moreover, since a dedicated inspection apparatus performs inspection instead of operator's visual inspection, stable inspection can be done, thus improving the printing quality.

### BRIEF DESCRIPTION OF THE DRAWINGS

FIG. 1 is a side view showing the schematic arrangement of a identification mark printing machine according to an embodiment of the present invention;

FIG. 2 is a side view showing an array of cylinders of a printing unit shown in FIG. 1;

FIG. 3 is a side view showing cylinder throw-on and throw-off devices of the identification mark printing machine shown in FIG. 1;

FIG. 4 is a block diagram showing the electrical configuration of the identification mark printing machine shown in FIG. 1; and

FIG. 5 is a side view showing a identification mark printing machine according to a Comparative Example.

### DESCRIPTION OF THE PREFERRED EMBODIMENT

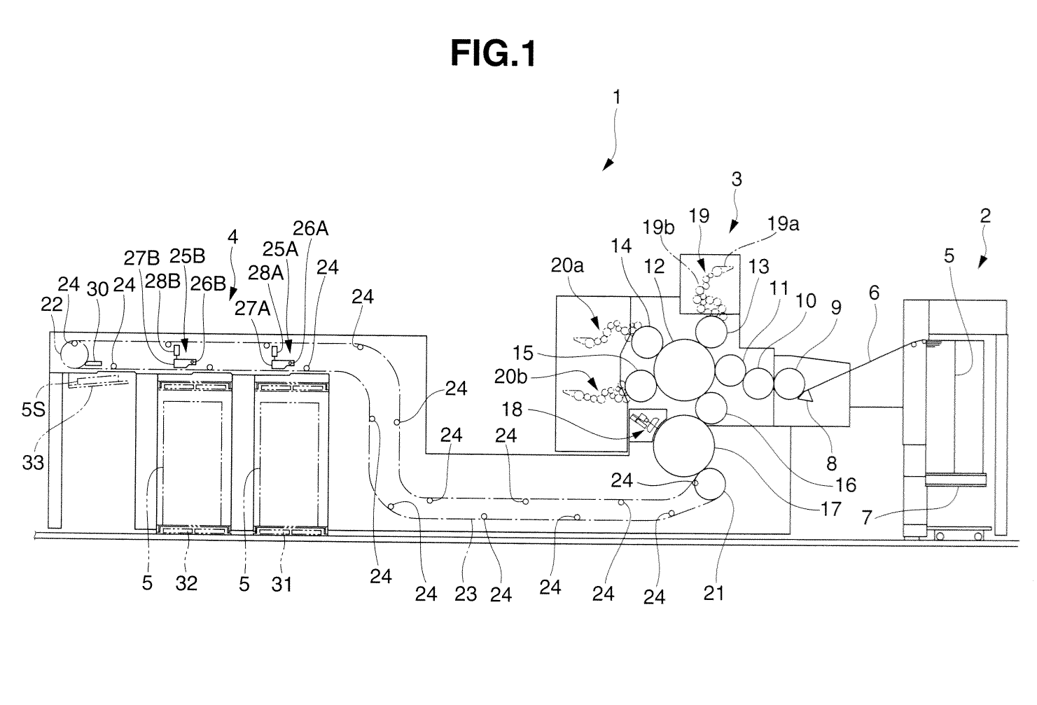

An embodiment of the present invention will be described below with reference to FIGS. 1 to 4.

A identification mark printing machine 1 according to this embodiment includes a sheet feed unit 2 which feeds stacked sheets 5 having images printed on them to a feeder board 6 one by one, a printing unit 3 which additionally prints seals and numbers on the images on the sheets 5 fed from the sheet feed unit 2, and a sheet delivery unit (sheet discharge unit) 4 which delivers the sheets 5 having the seals and numbers printed on them by the printing unit 3, as shown in FIG. 1.

The sheet feed unit 2 includes a pile board (stack board) 7 which stacks a large number of sheets 5 having images printed on them by a printing machine different from the identification mark printing machine 1. The sheets 5 stacked on the pile board 7 are drawn by suction by a sucker device (not shown) one by one, fed to the feeder board 6, and further fed to the printing unit 3 via a transfer cylinder 9 by a swing arm shaft pregripper 8.

The printing unit 3 includes an impression cylinder 12 which winds around its circumferential surface the sheet 5 received from the transfer cylinder 9 via transfer cylinders 10 and 11, and transports the sheet 5, a seal cylinder 13 which prints a seal (or a stamp) on the sheet 5 transported by the impression cylinder 12, a pair of number printing cylinders 14 and 15 which print numbers on the sheet 5 transported by the impression cylinder 12, a transfer cylinder 16 which is provided in contact with the impression cylinder 12, and transports the sheet 5 received from the impression cylinder 12, an inspection cylinder 17 which winds around its circumferential surface the sheet 5 received from the transfer cylinder 16, and transports the sheet 5, and an inspection device 18 which inspects the quality of the seal and numbers printed on the sheet 5 which is wound around the circumferential surface of the inspection cylinder 17 and transported by the inspection cylinder 17.

The transfer cylinders 9, 10, 11, and 16, seal cylinder 13, and number printing cylinders 14 and 15 have nearly the same diameter. The diameters of the impression cylinder 12 and inspection cylinder 17 are nearly double those of the transfer cylinders 9, 10, 11 and 16, the seal cylinder 13, and the number printing cylinders 14 and 15.

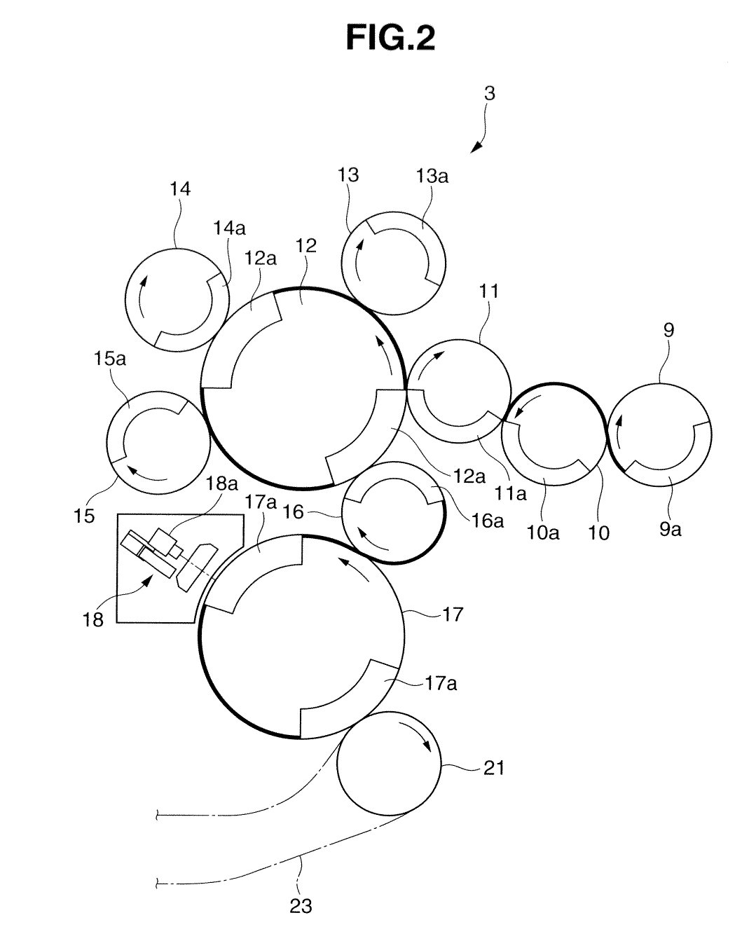

Notches 9a, 10a, and 11a are formed in the transfer cylinders 9, 10, and 11, respectively, so that notches formed in adjacent cylinders are opposed to each other, as shown in FIG. 2. Notches 13a, 14a, 15a, and 16a are formed in the circumferential surfaces of the seal cylinder 13, number printing cylinders 14 and 15, and transfer cylinder 16, respectively. A pair of notches 12a are formed in the circumferential surface of the impression cylinder 12 at positions 180° out of phase with each other in the circumferential direction. The pair of notches 12a in the impression cylinder 12 are opposed to the notch 11a in the transfer cylinder 11, the notch 13a in the seal cylinder 13, the notch 14a in the number printing cylinder 14, the notch 15a in the number printing cylinder 15, and the notch 16a in the transfer cylinder 16. Among these notches, the notches 9a, 10a, 11a, 12a, and 16a in the transfer cylinders 9, 10, and 11, impression cylinder 12, and transfer cylinder 16, respectively, are provided with gripper devices (not shown) serving as sheet holding devices which hold the leading edge (gripping edge) of the sheet 5.

The pair of number printing cylinders 14 and 15 include pluralities of numbering devices circumferentially arranged on rotating shafts (not shown) via mount rings. The number printing cylinders 14 and 15 are driven by numeric shift mechanisms provided at their shaft ends, and the digits indicated by the numbering devices are incremented by one for every rotation of the number printing cylinders 14 and 15. A pair of notches 17a are formed in the circumferential surface of the inspection cylinder 17 at positions which are 180° out of phase with each other in the circumferential direction and are opposed to the notch 16a in the transfer cylinder 16. A large number of suction holes (not shown) supplied with suction air are formed in the circumferential surface of the inspection cylinder 17 at positions at which the notches 17a are not formed. Thus, the sheet 5 transferred from the transfer cylinder 16 is transported while being drawn on the circumferential surface of the inspection cylinder 17 by the suction air from the large number of suction holes. The notches 17a in the inspection cylinder 17 are provided with a gripper device (not shown) serving as a sheet holding device which holds the leading edge (gripping edge) of the sheet 5.

The inspection device 18 includes an inspection camera 18a opposed to the circumferential surface of the inspection cylinder 17. The inspection camera 18a inspects the printing quality of the seal and numbers printed on the sheet 5 which is wound around the circumferential surface of the inspection cylinder 17 and transported by the inspection cylinder 17, and inspects whether the printed numbers coincide with the numbers normally expected to be printed.

As shown in FIG. 1, an inker 19 includes an ink fountain 19a and a large number of rollers 19b, and supplies ink in the ink fountain 19a onto the seal cylinder 13 via the rollers 19b. Inkers 20a and 20b include ink fountains and large numbers of rollers, and supply ink onto the pair of number printing cylinders 14 and 15, respectively, like the inker 19.

A pair of delivery chains 23 are suspended between a sprocket (not shown), coaxial with a delivery cylinder 21 arranged in contact with the inspection cylinder 17, and a sprocket 22, arranged at the terminal end of the sheet delivery unit 4, with a predetermined spacing between them in the widthwise direction. A plurality of delivery grippers 24 that serve as gripper bars are juxtaposed on gripper shafts supported between the pair of delivery chains 23 with predetermined spacings between them. The delivery grippers 24 receive the sheet 5, gripped by the gripper device of the inspection cylinder 17, in cooperation with the delivery cylinder 21, and transport it as the delivery chains 23 travel.

A delivery cam moving device 25A is provided above a delivery pile (discharge pile) 31. The delivery cam moving device 25A includes a delivery cam (discharge cam) 27A pivotally supported by a pair of delivery frames (not shown) to have a shaft 26A as a pivot center, and an air cylinder 28A which moves the delivery cam 27A between the extension position to which it extends toward the traveling path of the delivery grippers 24 (the traveling path of the cam follower of the delivery grippers 24), and the retraction position to which it retracts from this traveling path.

In this arrangement, when the delivery cam 27A extends to the traveling path of the delivery grippers 24 upon driving of the air cylinder 28A in one direction, the cam follower (not shown) of the delivery grippers 24 engages with the delivery cam 27A to cancel gripping of the sheet 5 by the delivery grippers 24, thereby delivering the sheet 5 to the delivery pile 31. On the other hand, when the delivery cam 27A retracts from the traveling path of the delivery grippers 24 upon driving of the air cylinder 28A in the other direction, the cam follower (not shown) of the delivery grippers 24 does not engage with the delivery cam 27A. Therefore, the delivery grippers 24 pass through a portion below the delivery cam 27A while continuing to grip the sheet 5.

A delivery cam moving device 25B is provided above a delivery pile 32 on the downstream side of the delivery cam moving device 25A in the direction in which the sheet 5 is transported. The delivery cam moving device 25B includes a delivery cam (discharge cam) 27B pivotally supported by a pair of delivery frames (not shown) to have a shaft 26B as a pivot center, and an air cylinder 28B which moves the delivery cam 27B between the extension position to which it extends toward the traveling path of the delivery grippers 24 (the traveling path of the cam follower of the delivery grippers 24), and the retraction position to which it retracts from this traveling path.

In this arrangement, when the delivery cam 27B extends to the traveling path of the delivery grippers 24 upon driving of the air cylinder 28B in one direction, the cam follower (not shown) of the delivery grippers 24 engages with the delivery cam 27B to cancel gripping of the sheet 5 by the delivery grippers 24, thereby delivering the sheet 5 to the delivery pile 31. On the other hand, when the delivery cam 27B retracts from the traveling path of the delivery grippers 24 upon driving of the air cylinder 28B in the other direction, the cam follower (not shown) of the delivery grippers 24 does not engage with the delivery cam 27B. Therefore, the delivery grippers 24 pass through a portion below the delivery cam 27B while continuing to grip the sheet 5.

A fixing cam 30 is provided above a delivery pile 33 on the downstream side of the delivery cam 27B in the direction in which the sheet 5 is transported. The fixing cam 30 faces the traveling path of the delivery grippers 24 (the traveling path of the cam follower of the delivery grippers 24). With this arrangement, when both the delivery cams 27A and 27B are retracted from the traveling path of the delivery grippers 24, the delivery grippers 24 pass through a portion below the delivery cams 27A and 27B while continuing to grip the sheet 5. Therefore, the cam follower of the delivery grippers 24 engages with the fixing cam 30 to cancel gripping of the sheet 5 by the delivery grippers 24, thereby delivering the sheet 5 to the delivery pile 33.

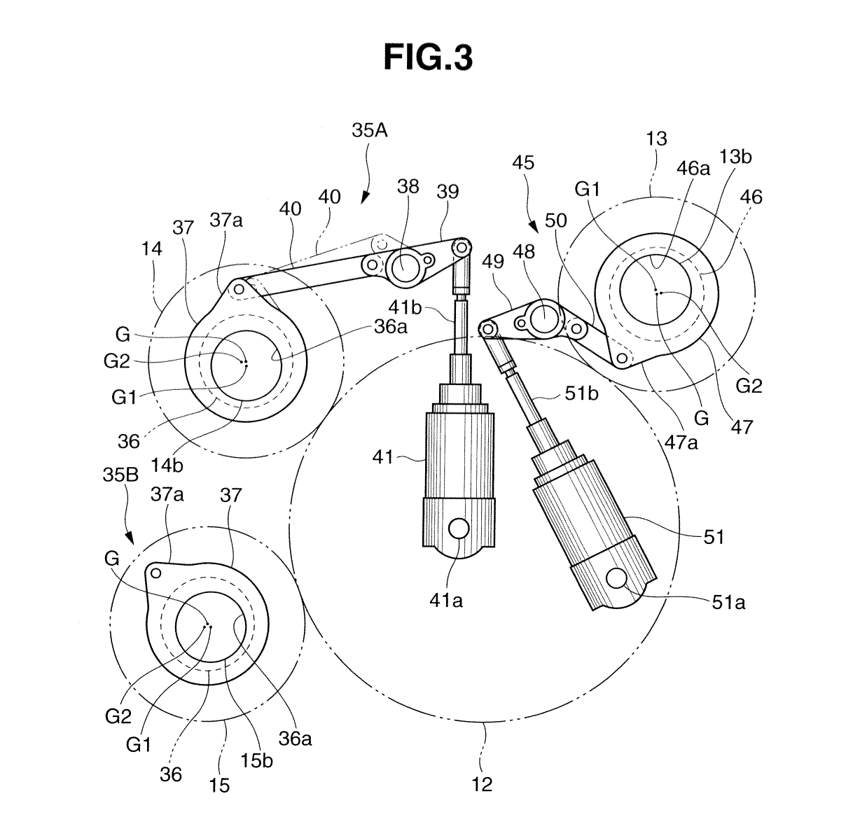

Number printing cylinder throw-on and throw-off devices 35A and 35B which move the pair of number printing cylinders 14 and 15, respectively, between the throw-on positions at which the pair of number printing cylinders 14 and 15 print numbers on the sheet 5 held on the impression cylinder 12, and the throw-off positions at which they are separated from the impression cylinder 12 will be described next with reference to FIG. 3. Note that since the number printing cylinder throw-on and throw-off devices 35A and 35B have the same arrangement and perform the same operation, only the number printing cylinder throw-on and throw-off device 35A will be described in detail hereinafter, and the number printing cylinder throw-on and throw-off device 35B will be described only where necessary. Hence, FIG. 3 does not show the detailed arrangement of the number printing cylinder throw-on and throw-off device 35B which moves the number printing cylinder 15.

The number printing cylinder 14 is pivotally, axially supported by a pair of frames (not shown) via a pair of eccentric bearings 36 (one eccentric bearing 36 is not shown). The pair of eccentric bearings 36 have shaft cores G1 of inner shaft holes 36a decentered with respect to shaft cores G of circles defined by their outer peripheries, and each end shaft 14b of the number printing cylinder 14 is rotatably, axially supported in the inner shaft hole 36a of the corresponding eccentric bearing 36. The outer peripheries of the pair of eccentric bearings 36 are pivotally, axially supported by the pair of frames. A pair of ring levers 37 (one ring lever 37 is not shown) are fixed to the pair of the eccentric bearings 36, and integrally pivot the pair of eccentric bearings 36.

On one side of the pair of frames, a pivot shaft 38 is pivotally, axially supported by the frame, and the central portion of a pivot lever 39 is axially mounted on the frame via the pivot shaft 38. The pivot lever 39 and ring lever 37 are connected to each other via a connection lever 40 having two ends pivotally supported by one end of the pivot lever 39 and a projection 37a of the ring lever 37. An air cylinder 41 is pivotally supported by the frame via a pivotal shaft 41a, and the other end of the pivot lever 39 is pivotally mounted at the distal end of an extendable rod 41b of the air cylinder 41.

On the other side of the pair of frames, a pivot lever 39 is axially mounted on the frame which axially supports a pivot shaft 38, and the ring lever 37 and one end of the pivot lever 39 are connected to each other via a connection lever 40. When the rod 41b of the air cylinder 41 provided on one side of the pair of frames extends/retracts, the ring levers 37 interlock to pivot via the pivot shafts 38.

In this arrangement, when the rod 41b of the air cylinder 41 retracts, each pivot shaft 38 pivots clockwise in FIG. 3 via the corresponding pivot lever 39, so each ring lever 37 pivots clockwise in FIG. 3, as indicated by an alternate long and two short dashed line, via the corresponding connection lever 40. Upon pivoting of each ring lever 37, the shaft core G1 of the inner shaft hole 36a of each eccentric bearing 36 moves to a shaft core G2 using the shaft core G as a pivot center, so the number printing cylinder 14 separates from the impression cylinder 12 and assumes a throw-off state.

On the other hand, when the rod 41b of the air cylinder 41 extends, each pivot shaft 38 pivots counterclockwise in FIG. 3 via the corresponding pivot lever 39, so each ring lever 37 pivots counterclockwise in FIG. 3, as indicated by a solid line, via the corresponding connection lever 40. Upon pivoting of each ring lever 37, the shaft core G2 of the inner shaft hole 36a of each eccentric bearing 36 moves to the shaft core G1 using the shaft core G as a pivot center, so the number printing cylinder 14 comes into contact with the impression cylinder 12 and assumes a throw-on state. In this manner, the air cylinder 41, pair of ring levers 37, pair of pivot shafts 38, pair of pivot levers 39, and pair of connection levers 40 constitute the number printing cylinder throw-on and throw-off device 35A which moves the number printing cylinder 14 between the throw-on position at which the number printing cylinder 14 prints a number on the sheet 5 held on the impression cylinder 12, and the throw-off position at which it is separated from the impression cylinder 12.

The number printing cylinder throw-on and throw-off device 35B which moves the number printing cylinder 15 between the throw-on position at which the number printing cylinder 15 prints a number on the sheet 5 held on the impression cylinder 12, and the throw-off position at which it is separated from the impression cylinder 12 includes an air cylinder 41, a pair of ring levers 37, a pair of pivot shafts 38, a pair of pivot levers 39, and a pair of connection levers 40, like the number printing cylinder throw-on and throw-off device 35A.

In the number printing cylinder throw-on and throw-off device 35B, upon pivoting of each ring lever 37 clockwise in FIG. 3, a shaft core G1 of an inner shaft hole 36a of each, eccentric bearing 36 moves to a shaft core G2 using a shaft core G as a pivot center, so the number printing cylinder 15 with end shafts 15b separates from the impression cylinder 12 and assumes a throw-off state. On the other hand, upon pivoting of each ring lever 37 counterclockwise in FIG. 3, the shaft core G2 of the inner shaft hole 36a of each eccentric bearing 36 moves to the shaft core G1 using the shaft core G as a pivot center, so the number printing cylinder 15 comes into contact with the impression cylinder 12 and assumes a throw-on state.

A seal cylinder throw-on and throw-off device 45 which moves the seal cylinder 13 between the throw-on position at which the seal cylinder 13 prints a seal on the sheet 5 held on the impression cylinder 12, and the throw-off position at which it is separated from the impression cylinder 12 will be described next with reference to FIG. 3.

The seal cylinder 13 is pivotally, axially supported by a pair of frames (not shown) via a pair of eccentric bearings 46 (one eccentric bearing 46 is not shown). The pair of eccentric bearings 46 have shaft cores G1 of inner shaft holes 46a decentered with respect to shaft cores G of circles defined by their outer peripheries, and each end shaft 13b of the seal cylinder 13 is rotatably, axially supported in the inner shaft hole 46a of the corresponding eccentric bearing 46. The outer peripheries of the pair of eccentric bearings 46 are pivotally, axially supported by the pair of frames. A pair of ring levers 47 (one ring lever 47 is not shown) are fixed to the pair of the eccentric bearings 46, and integrally pivot the pair of eccentric bearings 46.

On one side of the pair of frames, a pivot shaft 48 is pivotally, axially supported by the frame, and the central portion of a pivot lever 49 is axially mounted on the frame via the pivot shaft 48. The pivot lever 49 and ring lever 47 are connected to each other via a connection lever 50 having two ends pivotally supported by one end of the pivot lever 49 and a projection 47a of the ring lever 37. An air cylinder 51 is pivotally supported by the frame via a pivotal shaft 51a, and the other end of the pivot lever 49 is pivotally mounted at the distal end of an extendable rod 51b of the air cylinder 51.

On the other side of the pair of frames, a pivot shaft 48 is pivotally, axially supported by the frame, and a pivot lever 49 is axially mounted on the frame via the pivot shaft 48. The ring lever 47 and one end of the pivot lever 49 are connected to each other via a connection lever 50. When the rod 51b of the air cylinder 51 provided on the frame on the other side extends/retracts, the ring levers 47 interlock to pivot via the pivot shafts 48.

In this arrangement, when the rod 51b of the air cylinder 51 retracts, each pivot shaft 48 pivots clockwise in FIG. 3 via the corresponding pivot lever 49, so each ring lever 47 pivots clockwise via the corresponding connection lever 50. Upon pivoting of each ring lever 47, the shaft core G1 of the inner shaft hole 46a of each eccentric bearing 46 moves to a shaft core G2 using the shaft core G as a pivot center, so the seal cylinder 13 separates from the impression cylinder 12 and assumes a throw-off state.

On the other hand, when the rod 51b extends, each pivot shaft 48 pivots counterclockwise in FIG. 3 via the corresponding pivot lever 49, so each ring lever 47 pivots counterclockwise via the corresponding connection lever 50. Upon pivoting of each ring lever 47, the shaft core G2 of the inner shaft hole 46a of each eccentric bearing 46 moves to the shaft core G1 using the shaft core G as a pivot center, so the seal cylinder 13 comes into contact with the impression cylinder 12 and assumes a throw-on state. In this manner, the air cylinder 51, pair of ring levers 47, pair of pivot shafts 48, pair of pivot levers 49, and pair of connection levers 50 constitute the seal cylinder throw-on and throw-off device 45 which moves the seal cylinder 13 between the throw-on position at which the seal cylinder 13 prints a seal on the sheet 5 held on the impression cylinder 12, and the throw-off position at which it is separated from the impression cylinder 12.

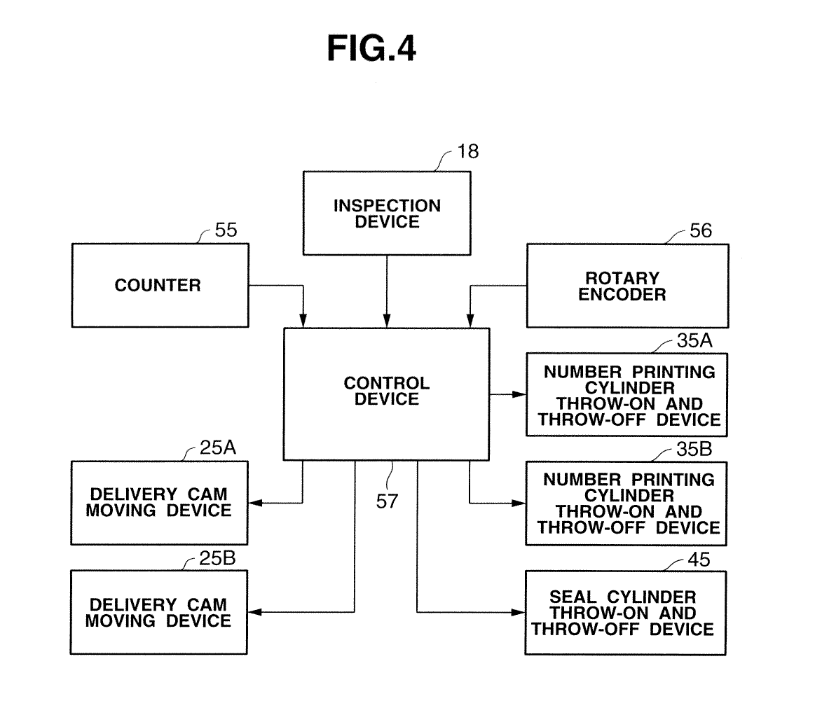

In a block diagram shown in FIG. 4, a control device 57 is electrically connected to a counter 55 and a rotary encoder 56, in addition to the above-mentioned inspection device 18, delivery cam moving devices 25A and 25B, number printing cylinder throw-on and throw-off devices 35A and 35B, and seal cylinder throw-on and throw-off device 45. The counter 55 counts the number of sheets 5 fed from the sheet feed unit 2 to the printing unit 3. The rotary encoder 56 detects the phase of each cylinder based on a rotation pulse output from the identification mark printing machine. The control device 57 controls driving of the delivery cam moving devices 25A and 25B, number printing cylinder throw-on and throw-off devices 35A and 35B, and seal cylinder throw-on and throw-off device 45 based on the outputs from the counter 55 and rotary encoder 56.

That is, if the control device 57 detects, based on the count signal from the counter 55, that a predetermined number of sheets 5 are delivered to the delivery pile 31, it retracts the delivery cam 27A of the delivery cam moving device 25A from the traveling path of the delivery grippers 24 based on the output from the rotary encoder 56. If the control device 57 detects, based on the count signal from the counter 55, that a predetermined number of sheets 5 are delivered to the delivery pile 32, it retracts the delivery cam 27B of the delivery cam moving device 25B from the traveling path of the delivery grippers 24. At the same time, the control device 57 extends the delivery cam 27A of the delivery cam moving device 25A to the traveling path of the delivery grippers 24 based on the output from the rotary encoder 56.

If the inspection device 18 detects an abnormality in the seal or numbers printed on the sheet 5, the control device 57 retracts the delivery cam 27A of the delivery cam moving device 25A from the traveling path of the delivery grippers 24. At the same time, the control device 57 retracts the delivery cam 27B of the delivery cam moving device 25B from the traveling path of the delivery grippers 24 based on the output from the rotary encoder 56.

Again, if the inspection device 18 detects an abnormality in the seal or numbers printed on the sheet 5, the control device 57 causes the number printing cylinder throw-on and throw-off devices 35A and 35B to throw the number printing cylinders 14 and 15 off the impression cylinder 12. At the same time, the control device 57 causes the seal cylinder throw-on and throw-off device 45 to throw the seal cylinder 13 off the impression cylinder 12. These types of control are performed while the number printing cylinders 14 and 15 and seal cylinder 13 do not print, that is, at the timing at which the notches 13a, 14a, and 15a in the cylinders 13, 14, and 15, respectively, are opposed to the notches 12a in the impression cylinder 12, based on the output from the rotary encoder 56.

A printing operation by the identification mark printing machine with the above-mentioned arrangement will be described next. In the initial state, the delivery cam 27A is extended to the traveling path of the delivery grippers 24, and the delivery cam 27B is retracted from the traveling path of the delivery grippers 24. In this state, the sheet 5 which has an image printed on it and is fed from the sheet feed unit 2 to the feeder board 6 is transferred by a gripping change to the grippers of the impression cylinder 12 by the swing arm shaft pregripper 8 via the transfer cylinders 9, 10, and 11, and is transported by the impression cylinder 12. During transportation of the sheet 5 by the impression cylinder 12, a seal is printed on the image printed on the sheet 5 by the seal cylinder 13, and numbers are printed on this image by the number printing cylinders 14 and 15.

The sheet 5 having the seal and numbers printed on it is transferred by a gripping change to the grippers of the inspection cylinder 17 via the transfer cylinder 16, and the printing quality of the seal and numbers is inspected by the inspection device 18 during transportation while the sheet 5 is kept in tight contact with the circumferential surface of the inspection cylinder 17. The sheet 5 determined to be normal by the inspection device 18 is transferred by a gripping change to the delivery grippers 24 and transported as the delivery chains 23 travel, and then gripping of the sheet 5 by the delivery grippers 24 is canceled, thereby delivering it to the delivery pile 31.

If the control device 57 detects, based on the count signal from the counter 55, that a predetermined number of sheets 5 are delivered to the delivery pile 31, it retracts the delivery cam 27A of the delivery cam moving device 25A from the traveling path of the delivery grippers 24 based on the output from the rotary encoder 56. At the same time, the control device 57 extends the delivery cam 27B of the delivery cam moving device 25B to the traveling path of the delivery grippers 24 based on the output from the rotary encoder 56. Thus, a sheet 5 transported after the predetermined number is counted passes through the delivery cam 27A while continuing to be gripped by the delivery grippers 24, and gripping of the sheet 5 by the delivery grippers 24 is canceled by the delivery cam 27B, thereby delivering it to the delivery pile 32.

On the other hand, if the inspection device 18 determines that the seal or numbers printed on the sheet 5 have an abnormality, the control device 57 performs control to retract the delivery cams 27A and 27B of the delivery cam moving devices 25A and 25B, respectively, from the traveling path of the delivery grippers 24, based on the output from the rotary encoder 56. Therefore, the sheet 5 which is detected to be abnormal passes through a portion below the delivery cams 27A and 27B while continuing to be gripped by the delivery grippers 24, and gripping of the sheet 5 by the delivery grippers 24 is canceled by the fixing cam 30, thereby delivering it to the delivery pile 33.

Further, the control device 57 controls (drives) the seal cylinder throw-on and throw-off device 45 at the timing at which the notch 13a in the seal cylinder 13 is opposed to the notches 12a in the impression cylinder 12, based on the output from the rotary encoder 56. Thus, the seal cylinder 13 is located at the throw-off position at which it is separated from the impression cylinder 12. At the same time, the control device 57 controls (drives) the number printing cylinder throw-on and throw-off devices 35A and 35B at the timing at which the notches 14a and 15a in the number printing cylinders 14 and 15, respectively, are opposed to the notches 12a in the impression cylinder 12, based on the output from the rotary encoder 56. Thus, the number printing cylinders 14 and 15 are located at the throw-off positions at which they are separated from the impression cylinder 12.

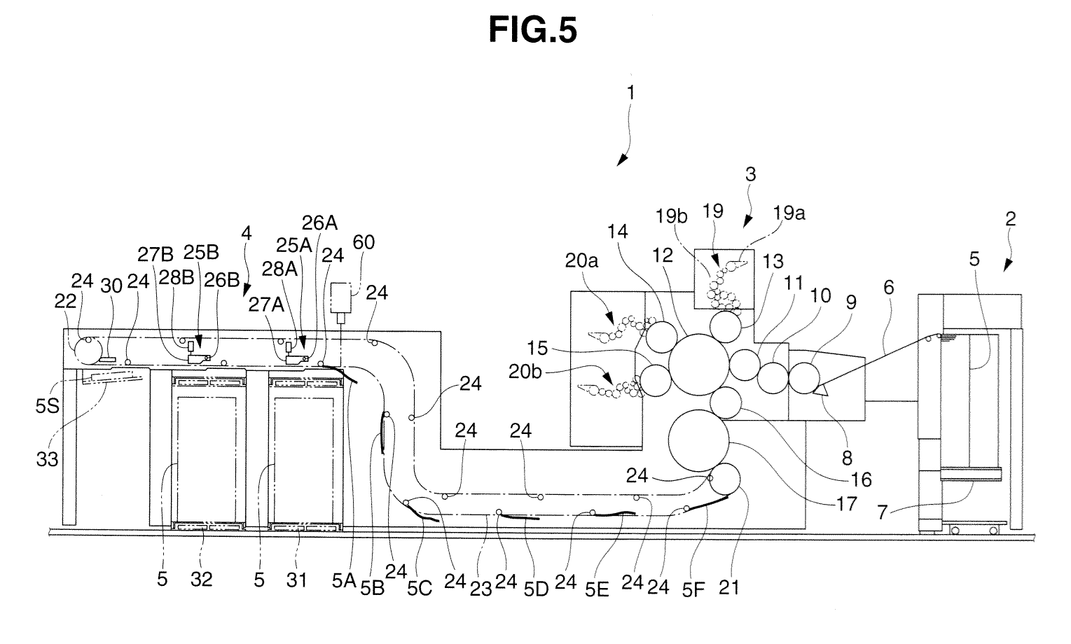

According to this embodiment, one transfer cylinder 16 alone is interposed between the impression cylinder 12 and the inspection cylinder 17. Therefore, if the inspection device 18 detects an abnormality, the printing operation by the seal cylinder 13 and number printing cylinders 14 and 15 can be immediately stopped, thus minimizing the occurrence of waste sheets. For example, as shown in FIG. 5, when an inspection device 60 is provided at the position at which the sheet 5 is inspected immediately before it is delivered to the delivery pile 31, at least six sheets 5A to 5F gripped by the delivery grippers 24 in the interval between the delivery cylinder 21 and the delivery pile 31 are wasted. This reveals that the occurrence of waste sheets can be suppressed in the above-mentioned embodiment, compared to this Comparative Example.

Although a seal and/or a number are printed on a sheet as an identification mark in the above-mentioned embodiment, the present invention is not limited to this, and is also applicable when other identification marks such as a code, a character, and a pictograph are printed. In this case, in place of a seal cylinder/number printing cylinder, a code cylinder, a character cylinder, and a pictograph cylinder which print a code, a character, and a pictograph, respectively, for example, need only be used as identification mark printing cylinders. Also, an anti-counterfeit mark printing cylinder which prints an anti-counterfeit mark may be used.

Also, although both a seal cylinder which prints a seal, and a number printing cylinder which prints a number are provided in the identification mark printing machine in the above-mentioned embodiment, a identification mark printing machine including only one of a seal cylinder and a number printing cylinder may be used. Moreover, although a double-diameter cylinder is used as an inspection cylinder, a unit-diameter cylinder or a triple-diameter cylinder may be used in accordance with the performance of the inspection camera.

What is claimed is:

1. A identification mark printing machine comprising:
an impression cylinder which holds and transports a sheet having an image printed thereon;
an identification mark cylinder which is in contact with said impression cylinder, and further prints an identification mark on the sheet held on said impression cylinder;
a transfer cylinder which is in contact with said impression cylinder on a downstream side, in a direction in which the sheet is transported, of a position at which said impression cylinder and said identification mark cylinder are in contact with each other, and holds and transports the sheet received from said impression cylinder;
an inspection cylinder which is in contact with said transfer cylinder, and holds and transports the sheet received from said transfer cylinder; and
an inspection device which inspects the identification mark printed on the sheet held on said inspection cylinder.

2. A machine according to claim 1, further comprising:
a throw-on and throw-off device which moves said identification mark cylinder between a throw-on position at which said identification mark cylinder prints an identification mark on the sheet held on said impression cylinder, and a throw-off position at which said identification mark cylinder is separated from said impression cylinder; and
a control device which controls said throw-on and throw-off device to move said identification mark cylinder from the throw-on position to the throw-off position when the inspection result obtained by said inspection device shows an abnormality.

3. A machine according to claim 1, further comprising:
a first delivery pile to which a sheet on which an identification mark is normally printed on an image printed thereon is delivered;
a second delivery pile to which a sheet on which an identification mark is abnormally printed on an image printed thereon is delivered;
a distribution device which distributes printed sheets into said first delivery pile and said second delivery pile; and
a control device which controls said distribution device to distribute the sheet having the identification mark printed thereon to said first delivery pile when the inspection result obtained by said inspection device shows normality, and to distribute the sheet having the identification mark printed thereon to said second delivery pile when the inspection result obtained by said inspection device shows an abnormality.

4. A machine according to claim 1, wherein said identification mark cylinder includes a number printing cylinder which prints a number on the sheet as the identification mark.

5. A machine according to claim 1, wherein said identification mark cylinder includes a seal cylinder which prints a seal on the sheet as the identification mark.
